(19) United States
(12) Patent Application Publication
(10) Pub. No.: US 2023/0087553 A1
(43) Pub. Date: Mar. 23, 2023

(54) COMMUNICATION SERVER, COMMUNICATION SYSTEM, AND NON-TRANSITORY COMPUTER READABLE MEDIUM

(71) Applicant: FUJIFILM Business Innovation Corp., Tokyo (JP)

(72) Inventor: Koji TATEISHI, Kanagawa (JP)

(73) Assignee: FUJIFILM Business Innovation Corp., Tokyo (JP)

(21) Appl. No.: 17/711,515

(22) Filed: Apr. 1, 2022

(30) Foreign Application Priority Data
Sep. 22, 2021 (JP) 2021-153741

(51) Int. Cl. G10L 21/02; G10L 15/02; G10L 15/08

(52) U.S. Cl. CPC G10L 21/02; G10L 15/02; G10L 15/08; G10L 2015/088

(57) ABSTRACT

A communication server includes a processor that processes voice data and that is configured to: function as a voice filter that extracts a voice component of a specific person; provide input voice data to the voice filter, the input voice data being received from a first terminal apparatus; and transmit output voice data to a second terminal apparatus different from the first terminal apparatus, the output voice data including a voice component that is output from the voice filter.

### CROSS-REFERENCE TO RELATED APPLICATIONS

This application is based on and claims priority under 35 USC 119 from Japanese Patent Application No. 2021-153741 filed Sep. 22, 2021.

### BACKGROUND

### (i) Technical Field

The present disclosure relates to a communication server, a communication system, and a non-transitory computer readable medium.

### (ii) Related Art

Communication systems are systems for communicating between multiple terminal apparatuses, in other words, between multiple users, over a network. A typical communication system example is an online meeting system. In an online meeting system, an online meeting server, serving as a communication server, distributes videos and voices.

Japanese Unexamined Patent Application Publication No. 2021-039219 discloses a technique for extracting voice components of a specific speaking person from a mixed voice signal. Japanese Unexamined Patent Application Publication No. 2002-304379 discloses a technique for authenticating a person by using their voiceprint. Japanese Unexamined Patent Application Publication Nos. 2021-039219 and 2002-304379 do not disclose a technique for relaying voice data in a communication system.

In a communication system, voice data is received/transmitted between terminal apparatuses through a communication server. Voice data may include unnecessary components (for example, voice components of non-attendees), which are not to be transmitted, as well as voice components of attendees who are using the communication system. Transmission of such unnecessary components to other attendees may be prevented or reduced.

### SUMMARY

Aspects of non-limiting embodiments of the present disclosure relate to a technique for preventing or reducing distribution of unnecessary components, which are included in voice data, in a communication server relaying voice data.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a communication server including a processor that processes voice data and that is configured to: function as a voice filter that extracts a voice component of a specific person; provide input voice data to the voice filter, the input voice data being received from a first terminal apparatus; and transmit output voice data to a second terminal apparatus different from the first terminal apparatus, the output voice data including a voice component that is output from the voice filter.

### BRIEF DESCRIPTION OF THE DRAWINGS

Exemplary embodiments of the present disclosure will be described in detail based on the following figures, wherein:

FIG. 1 is a block diagram illustrating an online meeting system according to an exemplary embodiment;

FIG. 2 is a block diagram illustrating an exemplary configuration of a voice distributing unit;

FIG. 3 is a diagram illustrating an exemplary online-meeting management table;

FIG. 4 is a diagram illustrating an exemplary filter management table;

FIG. 5 is a diagram for describing modification-mode execution conditions;

FIG. 6 is a diagram for describing a first example of filter generation;

FIG. 7 is a diagram for describing a second example of filter generation;

FIG. 8 is a diagram illustrating an application example;

FIG. 9 is a flowchart of a first operation example of an online meeting server;

FIG. 10 is a flowchart of a second operation example of an online meeting server; and

FIG. 11 is a block diagram illustrating a call system according to another exemplary embodiment.

### DETAILED DESCRIPTION

Exemplary embodiments of the present disclosure will be described below on the basis of the drawings.

### Overview of Exemplary Embodiment

A communication server according to an exemplary embodiment includes a processor which processes voice data. The processor functions as a voice filter which extracts voice components of a specific person. The processor provides, to the voice filter, input voice data received from a first terminal apparatus, and transmits output voice data, including voice components that are output from the voice filter, to a second terminal apparatus different from the first terminal apparatus.

The voice filter reduces or eliminates components (such as voice components other than those of the specific person, or audio components other than voice) other than voice components of the specific person. The output voice data, including voice components which have passed through the voice filter, is transmitted to the second terminal apparatus. Such a series of processes cause distribution of unnecessary components to be prevented or reduced.

Examples of the voice filter include a filter having a machine-learned model and a filter extracting voice components by using voice feature values (including voiceprint feature values). The concept of a communication server encompasses voice relay apparatuses, such as an online meeting server and a call server.

In the exemplary embodiment, the processor functions as a voice filter array including multiple voice filters. The processor selects, from the voice filter array, a voice filter to which input voice data is to be provided. The voice filters are generated in advance. This eliminates necessity of generating voice filters every time communication starts. All or some of the voice filter array may be shared in multiple communication sessions.

In the exemplary embodiment, the processor performs input switching control between a terminal apparatus group, including the first terminal apparatus and the second terminal apparatus, and the input side of the voice filter array. The processor performs output switching control between the output side of the voice filter array and the terminal apparatus group. Through the input switching control and the output switching control, each voice component is provided to its appropriate voice filter, and each filtered voice component is distributed to its appropriate terminal apparatuses.

In the exemplary embodiment, the input switching control includes voice-filter bypass control. The output switching control includes control for synthesizing multiple voice components, which are output from multiple voice filters in the voice filter array, to generate output voice data. Thus, the input switching control may include path selection on the input side of the filter array. The output switching control may include path selection and component synthesis on the output side of the filter array.

In the exemplary embodiment, the processor selects a voice filter, to which input voice data is to be provided, from the voice filter array in accordance with the identifier corresponding to the input voice data. The concept of the identifier may encompass, for example, an attendee identifier, a voice identifier, and a terminal apparatus identifier.

In the exemplary embodiment, the processor selects a first voice filter and a second voice filter, to which input voice data is to be provided, from the voice filter array in accordance with the first identifier and the second identifier corresponding to a first voice component and a second voice component which are included in the input voice data. Thus, the same input voice data may be provided to multiple voice filters in parallel.

In the exemplary embodiment, the processor transmits, to the second terminal apparatus, first output voice data including the first voice component which is output from the first voice filter. The processor transmits, to a third terminal apparatus, second output voice data including the second voice component which is output from the second voice filter. Multiple voice components, which are obtained through separation using multiple voice filters, are distributed to multiple terminal apparatuses.

In the exemplary embodiment, the processor transmits, to the first terminal apparatus, output voice data when the first terminal apparatus selects the recording mode. Thus, the first terminal apparatus performs recording to obtain recording data including filtered voice components.

In the exemplary embodiment, the processor generates or modifies a voice filter on the basis of sample voice data. The sample voice data is voice data which serves as a sample and which is obtained from the speaking person. The processor executes the modification mode when a modification-mode execution condition is satisfied. The processor uses, as sample voice data, voice data obtained in execution of the modification mode. A person's voice changes over time, and changes, for example, due to the person's physical condition. Execution of the modification mode achieves maintenance and improvement of the filtering quality of voice filters.

In the exemplary embodiment, the processor detects keyword data included in voice data. In this case, the case in which a modification-mode execution condition is satisfied is the case in which keyword data is detected. For example, one or more terms, which are used at the start of communication, may be registered as keywords in advance.

In the exemplary embodiment, the voice filters have filter models obtained through machine learning. Modification of the voice filters includes retraining the filter models. If retraining takes time, voice filters may be modified before the start of communication.

In the exemplary embodiment, the communication server is an online meeting server. The voice filters are shared in multiple online meetings. When a certain user attends multiple online meetings, use of the same voice filter in the online meetings may cause effective use of the resources.

A communication system according to the exemplary embodiment includes a communication server that includes a processor which processes voice data, and a first terminal apparatus and a second terminal apparatus that are connected to the communication server over a network. The processor functions as a voice filter that extracts voice components of a specific person. The processor provides, to the voice filter, input voice data received from the first terminal apparatus. The processor transmits, to the second terminal apparatus, output voice data including voice components that are output from the voice filter.

A program executed by a processor is installed in an information processing apparatus through a network or a portable storage medium. The program is stored in a non-transitory storage medium. The concept of the information processing apparatus encompasses various types of information processing devices such as a computer.

### Details of the Exemplary Embodiment

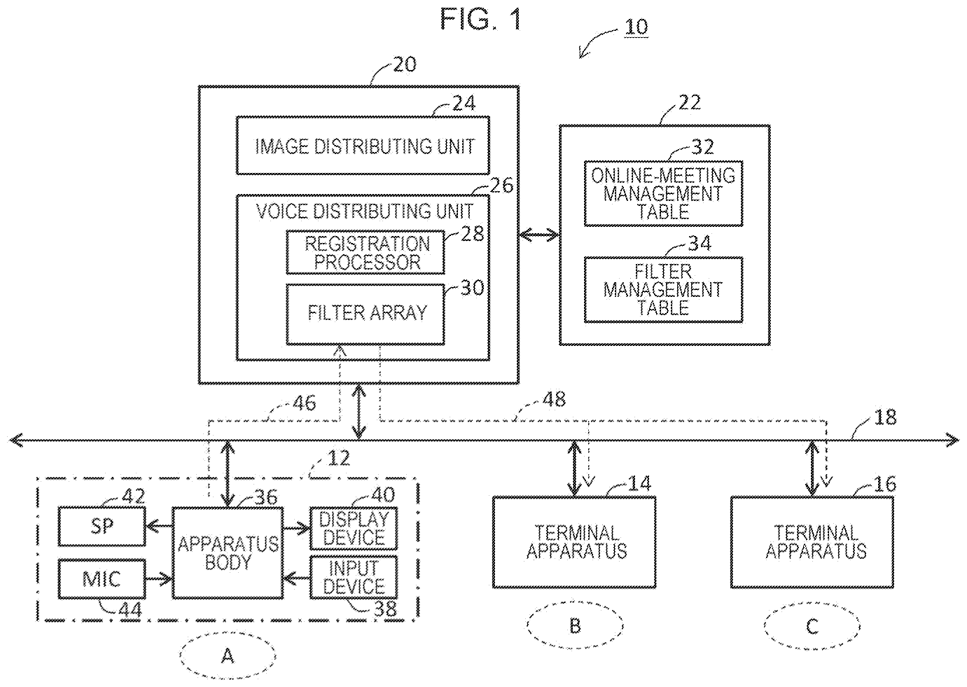

FIG. 1 illustrates an exemplary configuration of an online meeting system according to the exemplary embodiment. The online meeting system is a form of the communication system.

As illustrated in FIG. 1, the online meeting system includes an online meeting server 10 and multiple terminal apparatuses 12, 14, and 16 which are connected over a network 18. The network 18 is, for example, the Internet. The network 18 may be a local area network (LAN) such as an intranet, or may include a LAN. An online meeting is also referred to as a WEB meeting or a remote meeting.

The illustrated exemplary configuration is made under the assumption that attendee A, attendee B, and attendee C attend an online meeting. Attendee A uses the terminal apparatus 12; attendee B uses the terminal apparatus 14; attendee C uses the terminal apparatus 16. Attendees A, B, and C are users of the online meeting system.

The online meeting server 10, which is formed of an information processing apparatus such as a computer, functions as an apparatus for relaying images and voices. Specifically, the online meeting server 10 includes a processor 20, which performs programs, and a storage unit 22, which stores various data. The processor 20 performs multiple functions. These functions are represented by using multiple blocks in FIG. 1. The processor 20 is formed, for example, of a central processing unit (CPU). The storage unit 22 is formed, for example, of a semiconductor memory or a hard disk.

An image distributing unit 24 distributes, to the terminal apparatuses 12, 14, and 16, multiple images transmitted from the terminal apparatuses 12, 14, and 16. The terminal apparatuses 12, 14, and 16 display meeting images whose configurations have been changed by the respective terminal apparatuses.

A voice distributing unit 26 receives multiple pieces of voice data transmitted from the terminal apparatuses 12, 14, and 16, and distributes the pieces of voice data to the terminal apparatuses 12, 14, and 16. For example, voice data transmitted from the terminal apparatus 12 is distributed to the other terminal apparatuses 14 and 16. In distribution of voice data, multiple pieces of voice data are synthesized when necessary.

The voice distributing unit 26 includes a registration processor 28 and a filter array 30. The registration processor 28 performs registration which encompasses filter generation and filter modification. That is, the registration processor 28 functions as a filter generating unit and a filter modifying unit.

The filter generating unit generates voice filters (hereinafter referred to as filters simply). Each voice filter extracts voice components of a specific person (may be referred to as a user, an expected attendee, or a person whose voice is to be registered), who is scheduled to attend an online meeting or may attend the online meeting, and eliminates or reduces the other components on the basis of sample voice data obtained from the specific person prior to the online meeting. Examples of the other components to be eliminated or reduced include voice components other than those from a specific person, non-voice components, such as cries and barks of animals, machine sound, and instrumental sound. These components may be unnecessary to be distributed.

Multiple filters are generated on the basis of multiple pieces of sample voice data obtained from multiple persons whose voices are to be registered. The filter array 30 is formed of the filters. The filter array 30 may be referred to as a filter bank or a filter set. Prior to an online meeting, sample voice data may be transmitted from the terminal apparatuses 12, 14, and 16 to the online meeting server. Alternatively, voice data obtained at the beginning of an online meeting may be used as sample voice data.

The filter modifying unit modifies filters on the basis of newly obtained sample voice data when the filters satisfy modification-mode execution conditions. To cope with over-time change in voice or change in voice due to the attendees' physical conditions, filters are modified. Modification of filters will be described in detail below.

Examples of the filters included in the filter array 30 include a filter having a machine-learned model and a filter based on a voice feature value. For example, convolutional neural network (CNN) may be used generate a filter which extracts voice components of a specific person. The technique disclosed in Japanese Unexamined Patent Application Publication No. 2021-039219 may be used to generate a filter. The following filter may be used: the filter automatically determines whether a voice component of a specific person is present on the basis of the voice feature value obtained from a voiceprint, and passes only the voice component on the basis of the determination result.

The storage unit 22 stores an online-meeting management table 32 and a filter management table 34. Individual online meetings are managed in the online-meeting management table 32. Correspondences between individual users and individual filters are managed in the filter management table 34.

The terminal apparatuses 12, 14, and 16 have the same configuration. The configuration of the terminal apparatus 12 will be described. The terminal apparatus 12 is formed of a computer serving as an information processing apparatus. The terminal apparatus may be formed of a portable information processing device. The terminal apparatus 12 includes an apparatus body 36, an input device 38, a display device 40, a speaker 42, and a mike 44. The apparatus body 36 includes a processor which executes programs. The input device 38 is formed, for example, of a keyboard and a pointing device. The display device 40 is formed, for example, of a liquid-crystal display device. The speaker 42 and the mike 44 are used in online meetings. In recording an online meeting, image data and voice data, which are distributed, are stored in a memory (not illustrated).

The online meeting server 10 according to the exemplary embodiment includes the filter array 30, and has a function of distributing filtered voice data to the terminal apparatuses 12, 14, and 16. For example, as illustrated by using arrow 46, voice data including voice components of attendee A is provided from the terminal apparatus 12 to the processor 20. The processor 20 provides the voice data to the filter corresponding to attendee A. The filter extracts voice components of attendee A, that is, unnecessary components other than voice components of attendee A are eliminated or reduced. As illustrated by using arrow 48, voice data, including the voice components of attendee A which are output from the filter, is transmitted to the terminal apparatuses 14 and 16. Even when voice components of persons other than attendee A are included in the voice data received from the terminal apparatus 12, the voice components are eliminated or reduced due to the operation of the voice distributing unit 26. Thus, high-quality voice data is distributed to the terminal apparatuses 14 and 16.

The online meeting server 10 may be formed of multiple information processing apparatuses. In this case, the voice data processing part including the registration processor 28 and the filter array 30 may be separated from the other configuration.

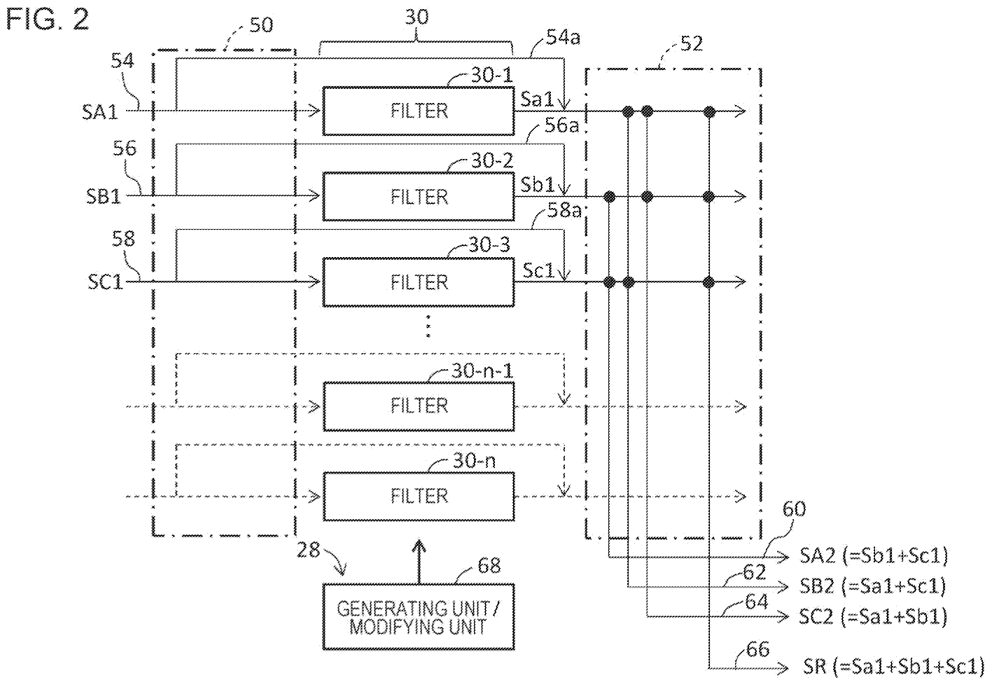

FIG. 2 schematically illustrates an exemplary configuration of the voice distributing unit 26. The filter array 30 is formed of multiple filters 30-1 to 30-n corresponding to multiple users. An input switching controller 50 is disposed on the input side of the filter array 30 (specifically, between the terminal apparatus group and the filter array 30). An output switching controller 52 is disposed on the output side of the filter array 30 (specifically, between the filter array 30 and the terminal apparatus group). The input switching controller 50 sets or selects paths for providing multiple pieces of voice data to filters appropriate for the voice data. The output switching controller 52 generates multiple pieces of voice data, which are to be distributed to multiple terminal apparatuses, on the basis of multiple voice components, which are output from multiple filters, typically, through synthesis of the voice components.

For example, input lines 54, 56, and 58 for three filters 30-1, 30-2, and 30-3 are illustrated schematically. The input lines 54, 56, and 58 are used to provide pieces of voice data SA1, SB1, and SC1, which are transmitted from the three terminal apparatuses 12, 14, and 16, to the filters 30-1, 30-2, and 30-3. As described above, the input switching controller 50 determines which piece of voice data is to be provided to which filter. The filter 30-1 extracts a voice component Sa1 of attendee A; the filter 30-2 extracts a voice component Sb1 of attendee B; the filter 30-3 extracts a voice component Sc1 of attendee C.

Three output lines 60, 62, and 64 to the three terminal apparatuses 12, 14, and 16 are illustrated schematically. Synthesized voice data SA2, flowing through the output line 60, has the voice components Sb1 and Sc1. Synthesized voice data SB2, flowing through the output line 62, has the voice components Sa1 and Sc1. Synthesized voice data SC2, flowing through the output line 64, has the voice components Sa1 and Sb1. In generation of the pieces of voice data SA2, SB2, and SC2, the output switching controller 52 synthesizes multiple voice components. In FIG. 2, multiple black points in the output switching controller 52 schematically represent multiple connections (connections for synthesis).

The input switching controller 50 has a function of causing voice data to bypass the individual filters 30-1 to 30-n. That is, the input switching control includes filter bypass control. When bypassing is selected, voice data is not filtered. Paths 54a, 56a, and 58a are paths for bypassing the filters 30-1, 30-2, and 30-3. Another method of processing voice data, which does not need filtering, separately without providing the voice data to the input switching controller 50 may be employed.

The output switching controller 52 has a function of generating voice data for recording. For example, an output line 66 is used for recording. Through the output line 66, voice data SR flows. The voice data SR includes the voice components Sa1, Sb1, and Sc1. That is, the voice data SR includes the voice component Sa1 of attendee A who uses the terminal apparatus 12, and the voice data SR is returned to the terminal apparatus 12. The terminal apparatus 12 records the voice data SR. The voice data SR is distributed to the other terminal apparatuses 14 and 16 when necessary.

As described above, the registration processor 28 functions as a generating unit/modifying unit 68 which indicates the generating unit and the modifying unit. The generating unit generates the filters 30-1 to 30-n. The modifying unit modifies the generated filters 30-1 to 30-n. For example, in modification of the filters 30-1 to 30-n, the machine-learned model may be retrained, or voice feature values may be extracted again.

Each piece of voice data has its identifier added thereto or associated therewith. The identifier is a user identifier. Alternatively, the identifier may be a voice identifier or a terminal apparatus identifier. The input switching controller 50 refers to the identifier corresponding to voice data, and selects a specific filter, to which the voice data is to be provided, on the basis of the identifier. At that time, the filter management table is referred to.

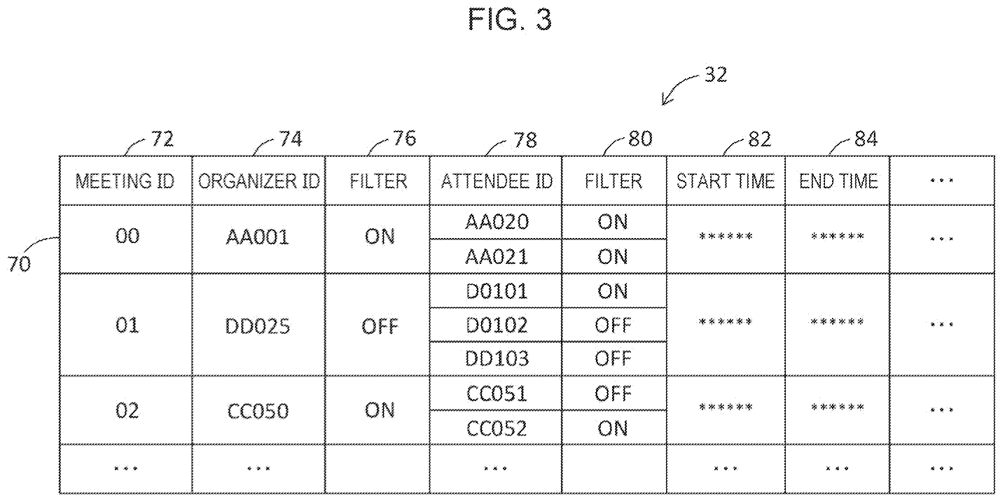

FIG. 3 illustrates an exemplary online-meeting management table. In the online-meeting management table 32, multiple pieces of online meeting information 70 corresponding to multiple online meetings are managed. Each piece of online meeting information 70 has pieces of information corresponding to the meeting ID 72, the organizer ID 74, the organizer filter on/off information 76, the attendee ID (user ID) 78, the attendee filter on/off information 80, the start time 82, the end time 84, and the like.

The input switching controller determines whether voice data of the organizer is to be filtered on the basis of the organizer filter on/off information 76. The input switching controller determines whether voice data of each attendee is to be filtered on the basis of the attendee filter on/off information 80. Whether filtering is to be performed may be collectively managed for each online meeting.

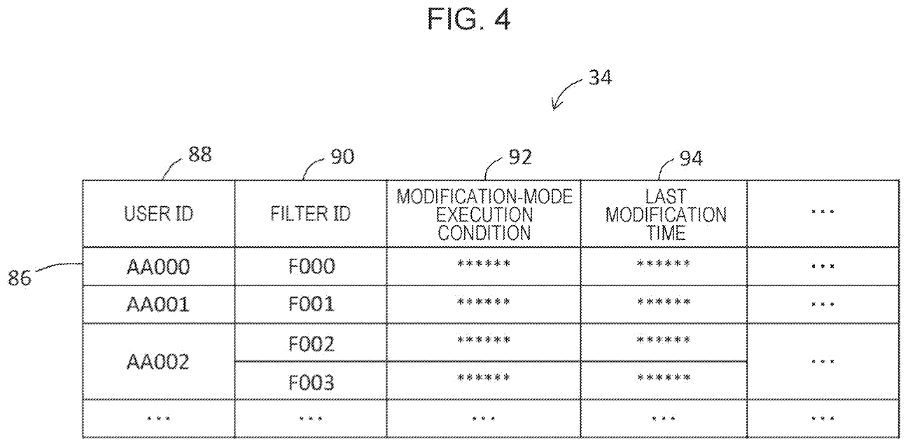

FIG. 4 illustrates an exemplary filter management table. The filter management table 34 has multiple pieces of filter management information 86 corresponding to multiple users. Each piece of filter management information 86 has pieces of information corresponding to the user ID 88, the filter ID 90, the modification-mode execution condition 92, the last modification time 94, and the like.

The input switching controller refers to the filter management table 34 to specify a correspondence between voice data and a filter. Actually, as described above, the input switching controller specifies the filter, to which the voice data is to be provided, on the basis of the user ID (identifier) corresponding to the voice data. When the modification-mode execution condition 92 is satisfied, execution of the modification mode starts. A modification-mode execution condition may be selected from multiple modification-mode execution conditions. The last modification time 94 indicates when the last modification of the filter was made.

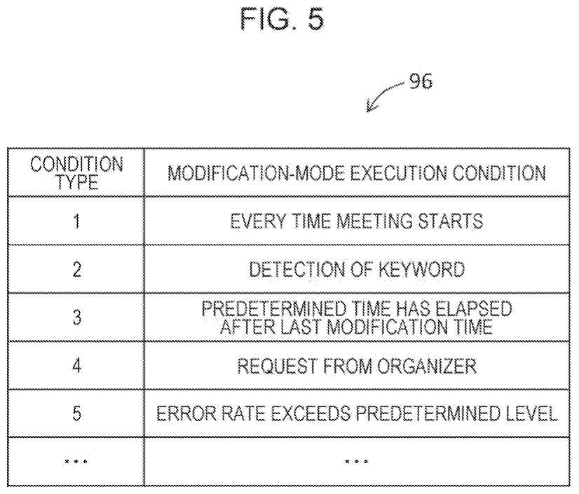

FIG. 5 describes some modification-mode execution conditions. As specified as condition type 1, every time an online meeting starts, one or more filters, which are scheduled to be used in the online meeting, may be modified, that is, updated. For example, at the beginning of an online meeting, the online server may require each attendee to input their voice data.

As specified as condition type 2, after an online meeting starts, when a keyword, which is registered in advance, is detected, execution of the modification mode may start automatically. For example, words or phrases, such as “I'll appreciate your cooperation” or “Let's start”, may be registered as keywords. In the case where this configuration is employed, a voice recognition module included in the online server may be used.

As specified as condition type 3, when a predetermined time has elapsed after the last modification time, the modification mode may start automatically. As specified as condition type 4, the organizer may request execution of the modification mode. As specified as condition type 5, when the quality of filtered voice data degrades, specifically, when the error rate exceeds a predetermined level, the modification mode may be executed automatically. In this case, a quality evaluation module included in the online meeting server may be used.

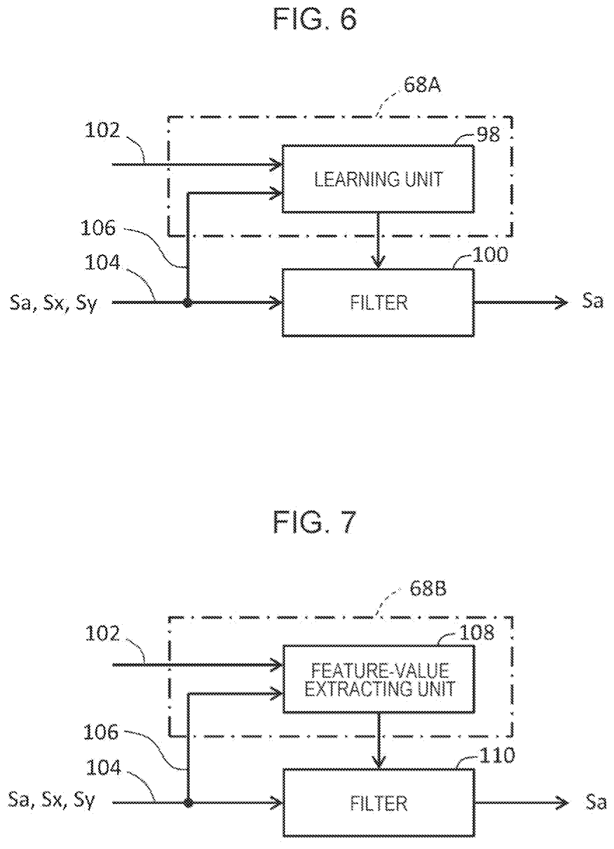

FIG. 6 illustrates a first example of filter generation. A part 68A indicates the generating unit and the modifying unit. A learning unit 98 performs machine learning on sample voice data 102 to generate a machine-learned model which is used as the actual body of a filter 100. When voice data 104 includes the speaking person's voice component Sa and other components Sx and Sy, the filter 100 extracts the voice component Sa. In modification of the filter, the voice data 104 may be used as sample voice data 106 to retrain the model.

FIG. 7 illustrates a second example of filter generation. A part 68B indicates the generating unit and the modifying unit. The sample voice data 102 is provided to a feature-value extracting unit 108 to extract a voice feature value. The voice feature value is provided to a filter 110. The filter 110 compares the voice feature value of the input voice data 104 with the voice feature value provided from the feature-value extracting unit 108. Specifically, the filter 110 calculates the distance (norm) between the two voice feature values. If the distance is within a certain value, the filter 110 passes the voice component. If the distance exceeds the certain value, the filter 110 blocks the voice component. When the voice data 104 includes the speaking person's voice component Sa and the other components Sx and Sy, the filter 110 extracts the voice component Sa. In modification of the filter, the voice data 104 may be used as the sample voice data 106 to modify or extract again the voice feature value.

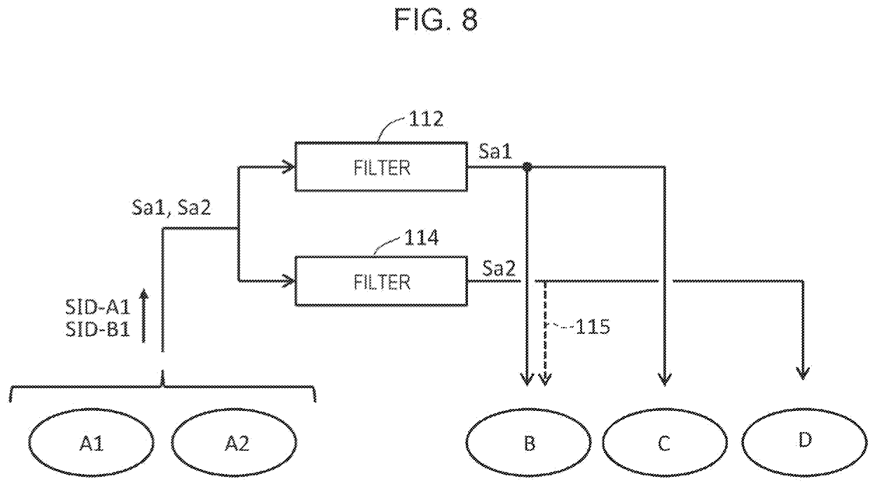

FIG. 8 illustrates an application example of the configuration according to the exemplary embodiment. Voice data including voice components Sa1 and Sa2 of attendees A1 and A2 is transmitted from the same terminal apparatus to the voice distributing unit of the online meeting server. Identifiers SID-A1 and SID-B1 for identifying attendees A1 and A2 are associated with the voice data.

The voice distributing unit selects two filters 112 and 114 on the basis of the identifiers SID-A1 and SID-B1. The common voice data is provided to the filters 112 and 114 in parallel. The filter 112 extracts the voice component Sa1. The filter 114 extracts the voice component Sa2. In the configuration example in FIG. 8, voice data including the voice component Sa1 is distributed to attendees B and C; voice data including the voice component Sa2 is distributed to attendee D.

For example, attendee A1 is a lecturer who projects their voice in Japanese; attendee A2 is a simultaneous interpreter who projects their voice in English. In this case, use of the scheme illustrated in FIG. 8 enables distribution of the voice data in Japanese to attendees B and C, and, at the same time, enables distribution of the voice data in English to attendee D. As illustrated by using arrow 115, attendee B may listen the voice data in English instead of or along with the voice data in Japanese.

For example, assume the case in which the utterances of attendee A1 and attendee A2, who are present in a meeting room, are being detected by the same terminal apparatus. In this case, use of the scheme in FIG. 8 enables distribution of the voice data of attendee A1 to attendees B and C, and, at the same time, enables distribution of the voice data of attendee A2 to attendee D. For example, this enables specific information to be transmitted only to attendee D.

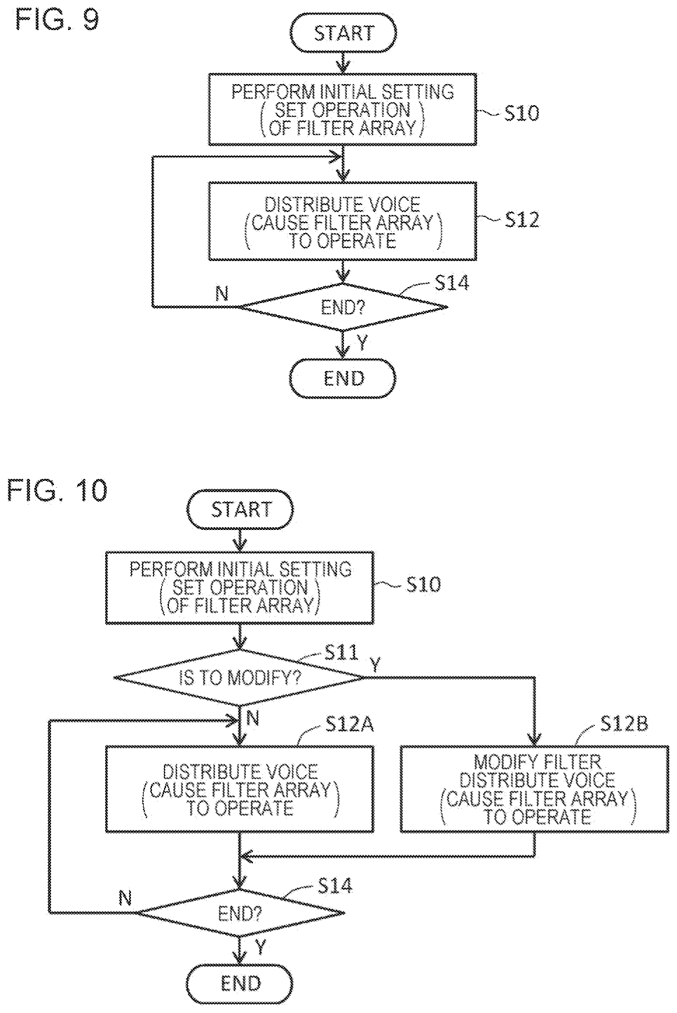

FIG. 9 illustrates, as a flowchart, a first operation example of the online server according to the exemplary embodiment. In S10, prior to an online meeting, initial setting is performed. The initial setting includes setting of the operation of the filter array. The input switching controller and the output switching controller are used to set the operation of the filter array. In S12, the online meeting starts, and the filter array starts to operate. Filtered voice data is distributed to the terminal apparatuses. The process described above is repeatedly performed until it is determined that the meeting ends in S14.

FIG. 10 illustrates, as a flowchart, a second operation example of the online server according to the exemplary embodiment. In FIG. 10, substantially the same processes as those in FIG. 9 are designated with the same process numbers, and will not be described.

In S11, it is determined whether the modification mode is to be executed. If the modification mode is not to be executed, in Sl2A, voice distribution starts, and, at the same time, the filter array starts to operate. If it is determined that the modification mode is to be executed in S11, in Sl2B, the modification mode is executed, and the filters corresponding to the attendees are modified individually. After that, voice distribution starts, and the filter array starts to operate in parallel.

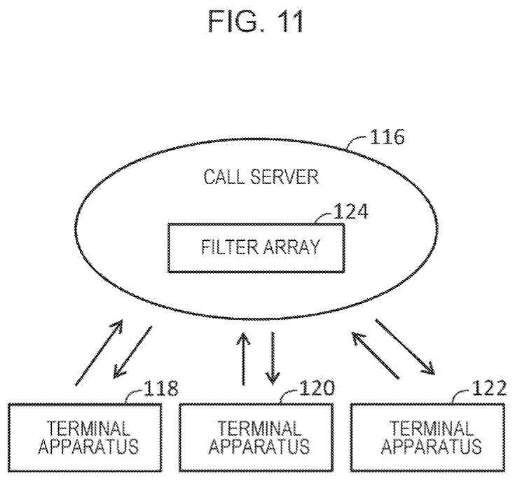

FIG. 11 illustrates another example of the communication system. The illustrated communication system is a call system, and includes a call server 116 and multiple terminal apparatuses 118, 120, and 122. The call server 116 relays voice data. The call server 116 includes a filter array 124. The filter array 124 has substantially the same configuration as that in FIG. 2. That is, voice data is filtered when necessary. The filtered voice data is distributed to the terminal apparatuses 118, 120, and 122. The call system may prevent components other than participants' voice components from being distributed to other terminal apparatuses.

In the embodiments above, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A communication server comprising:
a processor that processes voice data and that is configured to:
function as a voice filter that extracts a voice component of a specific person;
provide input voice data to the voice filter, the input voice data being received from a first terminal apparatus; and
transmit output voice data to a second terminal apparatus different from the first terminal apparatus, the output voice data including a voice component that is output from the voice filter.

2. The communication server according to claim 1,
wherein the processor is configured to:
function as a voice filter array including a plurality of voice filters; and
select the voice filter from the voice filter array, the voice filter being a filter to which the input voice data is to be provided.

3. The communication server according to claim 2,
wherein the processor is configured to:
perform input switching control between a terminal apparatus group and an input side of the voice filter array, the terminal apparatus group including the first terminal apparatus and the second terminal apparatus; and
perform output switching control between an output side of the voice filter array and the terminal apparatus group.

4. The communication server according to claim 3,
wherein the input switching control includes voice-filter bypass control.

5. The communication server according to claim 3,
wherein the output switching control includes control of synthesizing a plurality of voice components to generate the output voice data, the plurality of voice components being output from the plurality of voice filters in the voice filter array.

6. The communication server according to claim 2,
wherein the processor is configured to:
select the voice filter from the voice filter array in accordance with an identifier corresponding to the input voice data, the selected voice filter being a filter to which the input voice data is to be provided.

7. The communication server according to claim 6,
wherein the processor is configured to:
select a first voice filter and a second voice filter from the filter array in accordance with a first identifier and a second identifier corresponding to a first voice component and a second voice component, the first voice component and the second voice component being included in the input voice data, the first voice filter and the second voice filter being filters to which the input voice data is to be provided.

8. The communication server according to claim 7,
wherein the processor is configured to:
transmit first output voice data to the second terminal apparatus, the first output voice data including the first voice component that is output from the first voice filter; and
transmit second output voice data to a third terminal apparatus, the second output voice data including the second voice component that is output from the second voice filter.

9. The communication server according to claim 1,
wherein the processor is configured to:
when the first terminal apparatus selects a recording mode, transmit the output voice data to the first terminal apparatus.

10. The communication server according to claim 1,
wherein the processor is configured to:
generate or modify the voice filter on a basis of sample voice data.

11. The communication server according to claim 10,
wherein the processor is configured to:
when a modification-mode execution condition is satisfied, perform a modification mode; and
use, as the sample voice data, voice data obtained in execution of the modification mode.

12. The communication server according to claim 11,
wherein the processor is configured to:
detect keyword data included in the voice data, and
wherein the case in which a modification-mode execution condition is satisfied is a case in which the keyword data is detected.

13. The communication server according to claim 10,
wherein the voice filter has a machine-learned filter model, and
wherein modification of the voice filter includes retraining the filter model.

14. The communication server according to claim 1,
wherein the communication server is an online meeting server, and
wherein the voice filter is shared in a plurality of online meetings.

15. A communication system comprising:
a communication server including a processor that processes voice data; and
a first terminal apparatus and a second terminal apparatus that are connected to the communication server over a network,
wherein the processor is configured to:
function as a voice filter that extracts a voice component of a specific person;
provide input voice data to the voice filter, the input voice data being received from the first terminal apparatus; and
transmit output voice data to the second terminal apparatus, the output voice data including a voice component that is output from the voice filter.

16. A non-transitory computer readable medium storing a program causing a computer to execute, in an information processing apparatus, a process for functioning the information processing apparatus as a communication server, the process comprising:
functioning as a voice filter that extracts a voice component of a specific person;
providing input voice data to the voice filter, the input voice data being received from a first terminal apparatus; and
transmitting output voice data to a second terminal apparatus different from the first terminal apparatus, the output voice data including a voice component that is output from the voice filter.
